(19) United States
(12) Patent Application Publication
(10) Pub. No.: US 2013/0258641 A1
(43) Pub. Date: Oct. 3, 2013

(54) Backplane and Backlight Module Comprising Backplane

(71) Applicants: Yuchun Hsiao, Shenzhen (CN); Yicheng Kuo, Shenzhen (CN); Chong Huang, Shenzhen (CN); Jiahe Cheng, Shenzhen (CN); Pangling Zhang, Shenzhen (CN)

(72) Inventors: Yuchun Hsiao, Shenzhen (CN); Yicheng Kuo, Shenzhen (CN); Chong Huang, Shenzhen (CN); Jiahe Cheng, Shenzhen (CN); Pangling Zhang, Shenzhen (CN)

(21) Appl. No.: 13/504,958

(22) PCT Filed: Apr. 1, 2012
(86) PCT No.: PCT/CN12/73479

§ 371 Date: Apr. 29, 2012

(30) Foreign Application Priority Data
Mar. 29, 2012 (CN) 201210087592.6

(51) Int. Cl. G09F 13/04

(52) U.S. Cl. 362/97.1

(57) ABSTRACT

The invention provides a backplane and a backlight module including the backplane. The backplane is formed by joining a plurality of brackets; the plurality of brackets include light incident side bracket(s) for arranging the light source, and the structure part of the light incident side bracket for arranging the light source is coated with heat dissipation material. In the invention, because the part for arranging the light source of the backplane is coated with heat dissipation material, the heat dissipation efficiency of the part is increased, the heat of the part for arranging the light source of the backplane is rapidly dissipated, the temperature of the part is reduced, and the heat dissipation efficiency of the backlight module is increased. Thus, the inside temperature of the backlight module is reduced, and the phenomenon that the components in the backlight module are damaged or the service life thereof is affected because of overhigh temperature is avoided. In addition, the backplane processing technology and the material cost of the frame type backplane are reduced.

### TECHNICAL FIELD

The invention relates to the field of liquid crystal displays (LCDs), and more particularly to a backplane and a backlight module comprising the backplane.

### BACKGROUND

A conventional TFT-LCD device mainly includes: a bezel, a panel, and a backlight module; the backlight module includes a light source, a backplane and the like. The backplane is used for receiving optical film(s), the light source and the like, and is formed with corresponding hillocks on the backplane to lock and fix a system terminal or a panel circuit board.

FIG. 1 shows a conventional backplane structure. The backplane is generally formed by integratedly punching metal materia, and is formed with structures such as hillocks, etc. during punching to lock and fix the system terminal or panel circuit board. To increase the heat dissipation capacity of the backlight module, an aluminum extrusion with good heat dissipation effect is required to be arranged on the side wall of the backplane, the light source is arranged on the aluminum extrusion, and the side wall of the backplane is required to be provided with corresponding structure(s) such as locking hole(s) for fixing the aluminum extrusion because the fixation both between the aluminum extrusion and the backplane and between the aluminum extrusion and the light source is complicated. Furthermore, because heat is transferred by contact between the aluminum extrusion and the backplane, the heat of the aluminum extrusion cannot be rapidly transferred to the backplane, causing the heat of the aluminum extrusion to be accumulated, and the inside temperature of the backlight module to be high. In addition, by analyzing the cost of the LCD device, the inventor finds that the material cost of the backplane accounts for a large proportion; therefore, how to reduce cost becomes a problem to be solved urgently.

### SUMMARY

In view of the above-described problems, the aim of the invention is to provide a backplane and a backlight module comprising the backplane with the advantages of high heat dissipation efficiency, simple processing technology, and low material cost.

The aim of the invention is achieved by the following technical scheme.

A backplane, wherein the backplane is formed by joining a plurality of brackets comprising light incident side bracket(s) for arranging a light source, and the structure part of the light incident side bracket for arranging the light source is coated with heat dissipation material.

Preferably, the backplane comprises a left side bracket, a right side bracket, an upper side bracket, and a lower side bracket; the left side bracket of the backplane is used as a light incident side bracket, and the part of the left side bracket for arranging the light source is coated with heat dissipation material.

Preferably, the left side bracket is provided with a side wall, the light source is arranged on the inner side surface of the side wall of the left side bracket, and the heat dissipation material is coated on the outer side surface opposite to the inner side surface of the side wall. Thus, the heat dissipation efficiency of the side wall is increased, and heat is prevented from accumulating on the side wall.

Preferably, the whole left side bracket is coated with heat dissipation material. Because heat can be transferred to the bracket trunk from the side wall, the whole bracket is coated with heat dissipation material, facilitating the heat transfer by contact between the light source and the bracket, and further facilitating the heat dissipation of the whole bracket.

Preferably, the backplane comprises a left side bracket, a right side bracket, an upper side bracket, and a lower side bracket; the right side bracket of the backplane is used as a light incident side bracket, and the right side bracket is coated with heat dissipation material.

Preferably, the backplane comprises a left side bracket, a right side bracket, an upper side bracket, and a lower side bracket; the upper side bracket of the backplane is used as a light incident side bracket, and the upper side bracket is coated with heat dissipation material.

Preferably, the backplane comprises a left side bracket, a right side bracket, an upper side bracket, and a lower side bracket; the lower side bracket of the backplane is used as a light incident side bracket, and the lower side bracket is coated with heat dissipation material.

Preferably, the heat dissipation material is heat dissipation paint or radiative heat dissipation material. The coating process of the heat dissipation paint is simple, and the heat dissipation effect of the radiative heat dissipation material is better.

Preferably, the heat dissipation material is coated on the light incident side bracket of the backplane by brushing or spraying. Brushing mode has low cost, and the spraying mode is more suitable for mechanical coating and has high efficiency.

A backlight module comprises the aforementioned backplane.

Because the light source is a main source for emitting heat, the position for arranging the light source of the backplane has accumulated heat and high temperature. In the invention, because the part for arranging the light source of the backplane is coated with heat dissipation material, the heat dissipation efficiency of the part is increased, the heat of the part for arranging the light source of the backplane is rapidly dissipated, and the temperature of the part is reduced, thereby increasing the heat dissipation efficiency of the backlight module. Thus, the inside temperature of the backlight module is reduced, and the phenomenon that the components in the backlight module are damaged or the service life thereof is affected because of overhigh temperature is avoided. Meanwhile, the backplane of the invention is a frame type backplane comprising a plurality of brackets. Compared with an integrated backplane, because the light source of the frame type backplane is fixed on the light incident side bracket, the light incident side bracket of the frame type backplane has narrower width and simpler process for coating the heat dissipation material. Because of large volume, the integrated backplane needs to be fixed by large machinery and is difficult to be locally coated. Because the frame type backplane comprises a plurality of separated brackets, and the width of the light incident side bracket for fixing the light source is narrow, only the light incident side bracket needs to be coated with heat dissipation material, the process is simple, no large machinery is required for fixing, and then the processing cost is lowe. Furthermore, because the frame type backplane comprises a plurality of brackets, and the brackets are formed by directly cutting and processing a general section, the frame type backplane has good generality; large area of the backplane is omitted in the frame, namely most of material is saved, and then the material cost of the backplane is reduced. To sum up, the invention has the advantages that the heat dissipation efficiency of the backplane is increased, the processing technology of the backplane is reduced, and the material cost of the backplane is reduced.

### BRIEF DESCRIPTION OF FIGURES

FIG. 1 is a simplified structure diagram of a conventional integrated backplane;

FIG. 2 is a simplified structure diagram of a frame type backplane coated with heat dissipation material of an example of the invention;

FIG. 3 is a simplified structure diagram of a left side bracket of an example of the invention; and

FIG. 4 is a simplified structure diagram of a left side bracket provided with a lightbar of an example of the invention.

Legends: 100. frame type backplane; 101. left side bracket; 102. right side bracket; 103. upper side bracket; 104. lower side bracket; 105. middle bracket; 1011. side wall; 1012. bracket trunk; 110. heat dissipation material coating; 120. lightbar.

### DETAILED DESCRIPTION

The invention will further be described in detail in accordance with the figures and the preferred examples.

The invention will further be described in detail in accordance with a frame type backplane of low cost as an example. Optionally, the invention is also suitable for an integrated backplane, namely suitable for the backplane shown in FIG. 1.

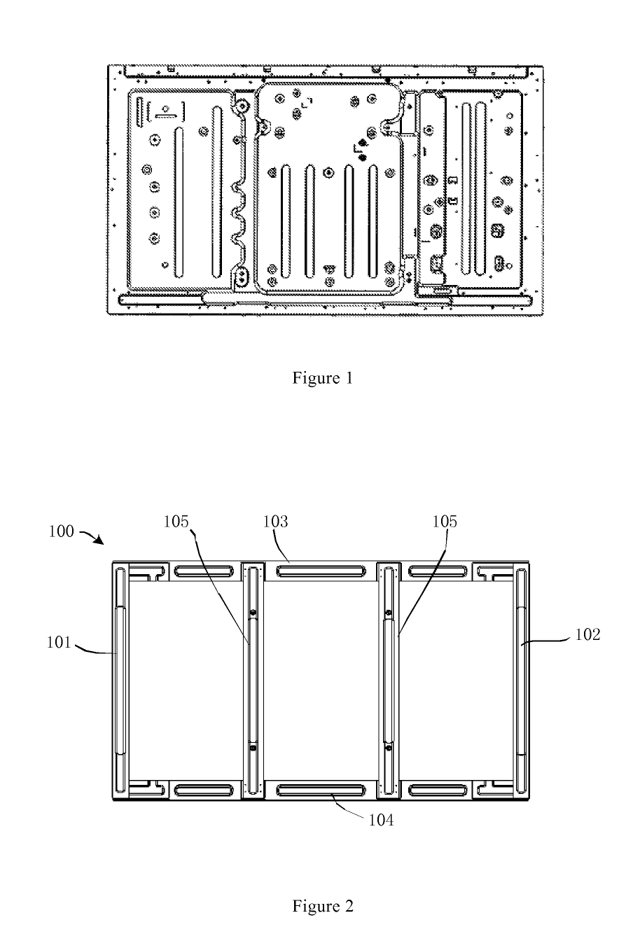

FIG. 2 shows an example of the invention. The frame type backplane 100 comprises a left side bracket 101, a right side bracket 102, an upper side bracket 103, a lower side bracket 104, and middle brackets 105; wherein the left side bracket 102 is used as a light incident side bracket and used for fixing the light source of the backlight module.

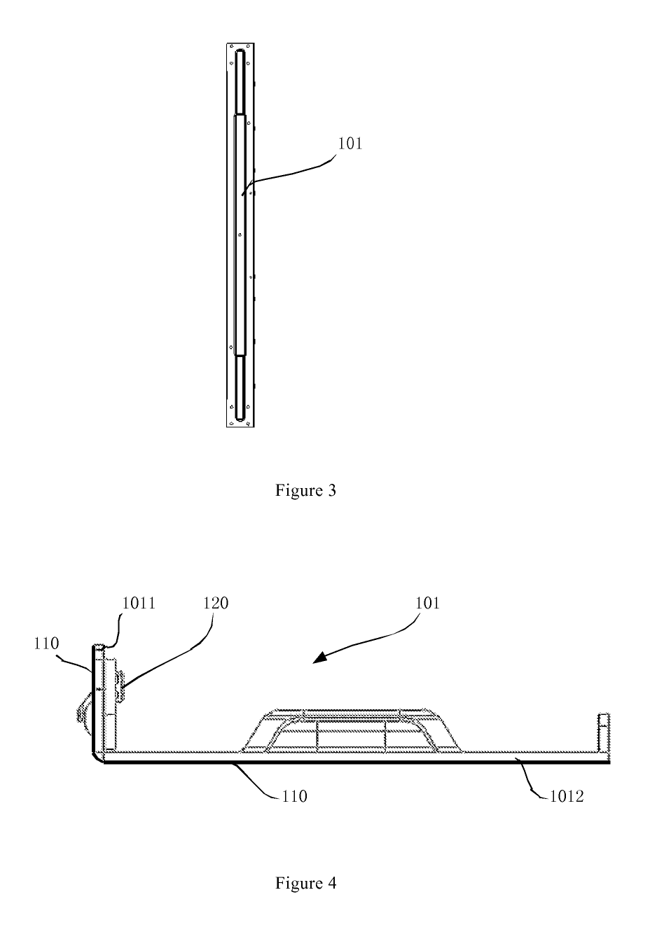

FIG. 3 and FIG. 4 show the left side bracket 101 of the frame type backplane 100. As shown in FIG. 5, the lightbar 120 is arranged on the inner side surface of the side wall 1011 of the left side bracket 101, heat is accumulated on the side wall 1011, and the outer side surface opposite to the inner side surface of the side wall 1011 is coated with a heat dissipation material coating 110, to increase the heat dissipation efficiency of the side wall 1011, and avoid the damage to components comprising LED chip(s), etc. when heat is accumulated on the side wall 1011. In addition, the heat of the side wall 1011 is transferred to a bracket trunk 1012, and the bracket trunk 1012 can be used for providing a heat dissipation path. As shown in FIG. 5, the back side of the bracket trunk 1012 is also provided with a heat dissipation material coating 110, to increase the heat dissipation efficiency of the bracket trunk 1012, and then increase the heat dissipation efficiency of the whole bracket.

Optionally, the whole left side bracket 101 can be coated with heat dissipation material; thus, the efficiency of heat transfer by contact between the left side bracket and the lightbar 120 can be increased, and the coating area of the heat dissipation material can be added, thereby increasing the heat dissipation efficiency.

In the example of the invention, both the heat dissipation paint and the radiative heat dissipation material can be used for the heat dissipation material coating 110, and these materials are easily coated on the backplane.

Moreover, for some LCD panels, the position where the light source is arranged is not the same as the example: if the light source is arranged on the right side bracket, the right side bracket is used as a light incident side bracket; if the light source is arranged on the upper side bracket, the upper side bracket is used as a light incident side bracket; if the light source is arranged on the lower side bracket, the lower side bracket is used as a light incident side bracket; or if the light source is simultaneously arranged on two or more than two brackets, all these brackets are used as light incident side brackets; thus, it is necessary to coat the light incident side bracket(s) in any above case with heat dissipation material to increase the heat dissipation efficiency.

Preferably, the whole frame type backplane is coated with heat dissipation material. Therefore, because the heat dissipation material covers the whole frame type backplane, the self heat conductivity of the frame type backplane is increased; thus, the heat of the light incident side bracket can be conducted to other brackets, and then other brackets can be used to dissipate heat.

As shown in FIG. 2, in the example of the invention, compared with the integrated backplane shown in FIG. 1, because the light source of the frame type backplane is fixed on the light incident side bracket 101, the light incident side bracket of the frame type backplane has narrower width and simpler process for coating the heat dissipation material. Because of large volume, the integrated backplane needs to be fixed by large machinery and is difficult to be locally coated. Because the frame type backplane comprises a plurality of separated brackets, and the width of the light incident side bracket 101 for fixing the light source is narrow, only the light incident side bracket needs to be coated with heat dissipation material; because of narrow width and small volume of the light incident side bracket, the frame type backplane is simply coated and does not needs to be fixed by large machinery; thus, the processing cost is lowe.

In the invention, the heat dissipation material can be coated on the light incident side bracket of the backplane or the whole backplane by simple brushing or by spraying which is more suitable for mechanical operation.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

1. A backplane, wherein said backplane is formed by joining a plurality of brackets, comprising: a left side bracket, a right side bracket, an upper side bracket, and a lower side bracket; the left side bracket of said backplane is used as a light incident side bracket used for arranging a light source of said backlight module, said left side bracket is provided with a side wall, said light source is arranged on the inner side surface of the side wall of said left side bracket, and the surface of said whole left side bracket is coated with heat dissipation material.

2. A backplane, wherein said backplane is formed by joining a plurality of brackets, said plurality of brackets comprise light incident side bracket(s) for arranging the light source, and the structure part of the light incident side bracket for arranging the light source is coated with heat dissipation material.

3. The backplane of claim 2, wherein said backplane comprises a left side bracket, a right side bracket, an upper side bracket, and a lower side bracket; the left side bracket of said backplane is used as a light incident side bracket, and the part of said left side bracket for arranging the light source is coated with heat dissipation material.

4. The backplane of claim 3, wherein said left side bracket is provided with a side wall, said light source is arranged on the inner side surface of the side wall of said left side bracket, and said heat dissipation material is coated on the outer side surface opposite to the inner side surface of said side wall.

5. The backplane of claim 3, wherein said whole left side bracket is coated with heat dissipation material.

6. The backplane of claim 2, wherein said backplane comprises a left side bracket, a right side bracket, an upper side bracket, and a lower side bracket; the right side bracket of said backplane is used as a light incident side bracket, and said right side bracket is coated with heat dissipation material.

7. The backplane of claim 2, wherein said backplane comprises a left side bracket, a right side bracket, an upper side bracket, and a lower side bracket; the upper side bracket of said backplane is used as a light incident side bracket, and said upper side bracket is coated with heat dissipation material.

8. The backplane of claim 2, wherein said backplane comprises a left side bracket, a right side bracket, an upper side bracket, and a lower side bracket; the lower side bracket of said backplane is used as a light incident side bracket, and said lower side bracket is coated with heat dissipation material.

9. The backplane of claim 2, wherein said heat dissipation material is heat dissipation paint or a radiative heat dissipation material.

10. The backplane of claim 2, wherein said heat dissipation material is coated on the light incident side bracket of said backplane by brushing or spraying.

11. A backlight module, comprising: a backplane; wherein said backplane is formed by joining a plurality of brackets; said plurality of brackets comprise light incident side bracket(s) for arranging the light source, and the structure part of the light incident side bracket for arranging the light source is coated with heat dissipation material.

12. The backplane of claim 11, wherein said backplane comprises a left side bracket, a right side bracket, an upper side bracket, and a lower side bracket; the left side bracket of said backplane is used as a light incident side bracket, and the part of said left side bracket for arranging the light source is coated with heat dissipation material.

13. The backlight module of claim 11, wherein said left side bracket is provided with a side wall, said light source is arranged on the inner side surface of the side wall of said left side bracket, and said heat dissipation material is coated on the outer side surface opposite to the inner side surface of said side wall.

14. The backlight module of claim 12, wherein said whole left side bracket is coated with heat dissipation material.

15. The backlight module of claim 11, wherein said backplane comprises a left side bracket, a right side bracket, an upper side bracket, and a lower side bracket; the right side bracket of said backplane is a used as a light incident side bracket, and said right side bracket is coated with heat dissipation material.

16. The backlight module of claim 11, wherein said backplane comprises a left side bracket, a right side bracket, an upper side bracket, and a lower side bracket; the upper side bracket of said backplane is used as a light incident side bracket, and said upper side bracket is coated with heat dissipation material.

17. The backlight module of claim 11, wherein said backplane comprises a left side bracket, a right side bracket, an upper side bracket, and a lower side bracket; the lower side bracket of said backplane is used as a light incident side bracket, and said lower side bracket is coated with heat dissipation material.

18. The backlight module of claim 11, wherein said heat dissipation material is heat dissipation paint or a radiative heat dissipation material.

19. The backlight module of claim 11, wherein said heat dissipation material is coated on the light incident side bracket of said backplane by brushing or spraying.
